(19) United States
(12) Patent Application Publication
(10) Pub. No.: US 2008/0111102 A1
(43) Pub. Date: May 15, 2008

(54) Chemical Mechanical Polishing Slurry

(75) Inventor: Akifumi YAO, Ube-shi (JP)

Correspondence Address: CROWELL & MORING LLP;INTELLECTUAL PROPERTY GROUP, P.O. BOX 14300, WASHINGTON, DC, 20044-4300, US

(73) Assignee: Central Glass Company, Limited, Ube-shi (JP)

(21) Appl. No.: 11/935,595

(22) Filed: Nov. 6, 2007

(30) Foreign Application Priority Data
Nov. 13, 2006 (JP) 2006-306585
Jul. 24, 2007 (JP) 2007-192130

(51) Int. Cl. C09K 13/00

(52) U.S. Cl. 252/79.1

(57) ABSTRACT

A polishing slurry for a chemical mechanical polishing. The polishing slurry includes an aqueous medium. A fluorinated nanodiamond is provided to be contained in the aqueous medium. Additionally, a fluorine-based surfactant is provided also to be contained in the aqueous medium.

### BACKGROUND OF THE INVENTION

The present invention relates to a polishing slurry for use in a chemical mechanical polishing or chemical mechanical planarization (hereinafter abbreviated as CMP) which is a polishing or planarizing technique used in a fabrication process of a semiconductor device.

The explosive spread of cellular phones, personal computers and the like has achieved remarkable developments in integration and speedup of a semiconductor device. With this, a circuit of the device has become more and more finely patterned over the years, and therefore the semiconductor market always requires a fabrication technique meeting such a fine patterning. CMP, which is one of techniques for producing the finely patterned circuit, is disclosed in U.S. Pat. No. 4,944,836 as a technique: for removing excess metals from an insulating layer on which a wiring metal is formed; for planarizing a metal wiring and the insulating layer; and for forming an embedded wiring. In general, CMP employs a polishing slurry in which an abrasive grit is dispersed. Properties of the abrasive grit exert a significant influence upon a polishing rate, the state of finished surface, and improvement of productivity, so that a material having a relatively high hardness is selected as the abrasive grit. Examples of the material used as the abrasive grit are diamond and metal oxides such as alumina, silica, zirconia and ceria. However, when a metal film (such as a copper film) which is lower than these abrasive materials in hardness is polished under use of these abrasive materials, there may arise scratching (a phenomenon where damage is made on a metal surface by polishing), dishing (a phenomenon where a metal is so polished as to have a concave surface), and peeling off of a metal layer. This brings about a problem of hindering the wiring formation, which should be solved in view of fabrication of a circuit that will be further finely patterned. In particular, diamond has the highest Mohs hardness in all materials so as to be expected to be the most excellent abrasive grit in terms of the polishing rate; however, it has been hardly used as the abrasive grit for CMP because of the problems such as the above-mentioned scratches.

A diamond obtained by a detonation (or impact method) in which a material is compressed by shock by means of negative oxygen balance explosives such as trinitrotoluene (TNT) and hexogen (RDX) is popularly known as “nanodiamond (ND)”. Primary particle of ND has a particle size of from 3 to 20 nm, which is considerably smaller than the size of the current circuit pattern so that the problems such as scratches are hard to occur. Even if scratches are made, they are so slight as not to be taken into consideration. Therefore, ND in the form of primary particle is expected to be used as the CMP abrasive grit for the circuit that will be further finely patterned in the future. However, ND is produced upon experiencing adhesion of a graphitic or non-graphitic film on particle surfaces of ND, so as to be provided to include: a secondary or tertiary coalescence having a particle size of from about 50 to 7500 nm; and further a huge coalescence consisting of the secondary and/or tertiary coalescence to have a particle size of several tens of micrometers. ND is therefore referred to as a cluster diamond (CD), as disclosed in Journal of Japan society of abrasive technology vol. 47, 414 (2003) by Eiji OSAWA, and in Journal of Japan society of abrasive technology vol. 47, 422 (2003) by Kotaro HANADA. In the case of industrially using ND as the abrasive grit for CMP, it is required that ND is provided in the form of a solution in which particles made by pulverizing CD (or a coalescence of ND) to have a particle size on the order of one to several hundreds nanometers are dispersed. However, CD (or a coalescence of ND) is so rigid that it is not easy to pulverize it to obtain ND in the form of primary coalescence. In the case of dispersing the pulverized ND particles in a solution, the smaller the particle size, the likelier coalescence among the particles occurs again thereby bringing about settlement or precipitation thereof. This makes it extremely difficult to produce a stable ND-particle dispersing solution. To solve the above problems, there are proposed various techniques. For example, Japanese Patent Provisional Publications Nos. 2005-1983 and 2005-97375 disclose a technique of pulverizing CD by a wet pulverization means such as a bead milling, and stably dispersing ND in a solution while keeping ND in the form of primary particle. According to this technique, most of the coalescences included in CD are pulverized so that a ND-particle dispersing solution having an average particle size of from about 4 to 8 nm can be obtained, and additionally it is reported that the ND-particle dispersing solution is excellent in long-term stability. However, an apparatus used in the technique of Japanese Patent Provisional Publications Nos. 2005-1983 and 2005-97375 can treat a small amount of CD per treating operation. Further, the apparatus is difficult to be scaled up due to its principle, which means a low productivity which is a problem to be studied. Furthermore, in this technique, CD is contaminated with impurities such as components other than ND (e.g. zirconia and silica) and a graphitic or non-graphitic film which adheres to particle surfaces of ND, due to the principle of the apparatus. This may cause a purity reduction so as not to sufficiently meet requirements of the market.

Meanwhile, there is reported in the summary of the 26^{th} fluorine conference of Japan (November, 2002) by: Tatsumi Ohi; Akiko Yamamoto; Shinji Kawasaki; Fujio Okino; and Hidekazu Touhara, a method of reacting CD with fluorine gas for the purpose of pulverizing the secondary and/or tertiary coalescence included in CD. In this method, CD is in contact with fluorine under conditions of: 300 to 500° C. of reaction temperature; 0.1 MPa of gas pressure; and 5 to 10 days of reaction time, thereby producing a fluorinated CD having a mole ratio (obtained by XPS and ultimate analysis) of [F/C] of about 0.2 while maintaining a diamond structure. It is observed by using TEM that the secondary and/or tertiary coalescence contained in CD and having a particle size of 50 to 7500 nm is partially pulverized by the above fluorination to have a particle size of around 200 nm. Moreover, the fluorinated CD is added to ethanol and then subjected to ultrasonics, thereby producing a particle-dispersing solution having a particle size of around 10 nm. It is therefore considered that the coalescence included in CD is pulverized to generate a fluorinated ND. The method for pulverizing the coalescence included in CD by fluorination allows scaling up of a reactor relatively readily, and is therefore considered to be superior to the pulverizing method using the wet pulverization means such as the bead milling, in terms of productivity. Further, a non-graphitic carbon is removed from surfaces of ND by a high temperature reaction, which is clearly observed since a lattice pattern of ND is previously known by a TEM observation. Furthermore, there is an extremely low possibility of contamination with impurities (i.e., materials other than ND) as shown in the pulverizing method using the wet pulverization means such as the bead milling. On the other hand, it is reported by: Akiko Yamamoto; Tatsumi Ohi; Shinji Kawasaki; Fujio Okino; Fumiaki Kataoka; Eiji Osawa; and Hidekazu Touhara in the summary of the 83^{th} spring meeting of the chemical society of Japan (March, 2003) that the fluorinated ND is seriously reduced in friction coefficient as a result of a rotary friction test under use of a mixture powder of the fluorinated ND and polytetrafluoroethylene (PTFE). This is because CF, CF₂ and CF₃ groups or the like are formed on the surfaces of ND thereby reducing a surface energy, which is reported by H. Touhara, K. Komatsu, T. Ohi, A. Yamamoto, S. Kawasaki, F. Okino and H. Kataura in Third French-Japanese Seminar on Fluorine in Inorganic Chemistry and Electrochemistry (April, 2003). The surface energy reduction in CMP is expected to bring about the effect of preventing the occurrence of scratches and the like. However, a compound of fluorine with an inorganic carbon-based material has a water repellency generally, so that the fluorinated ND also has the water repellency without exception. With this property, the fluorinated ND is not so much as wetted even when mixed with and briskly stirred in an aqueous medium generally used as the polishing slurry for CMP.

### SUMMARY OF THE INVENTION

However, the above-mentioned adoption of a high hardness material (e.g. diamond) as the abrasive grit for the purpose of accelerating the polishing rate in CMP causes the occurrence of scratches, dishing or the like. This raises a problem of impairing the wiring formation. On the other hand, when a material having a hardness equal to an object to be polished is adopted as the abrasive grit for the purpose of avoiding the occurrence of scrathces and the like, the abrasive grit is worn out in itself so that a stable polishing effect (such as a consistent polishing rate and a surface-planarizing ability) can not be obtained.

It is therefore an object of the present invention to provide an improved polishing slurry which can effectively overcome drawbacks encountered in conventional polishing slurries.

Another object of the present invention is to provide an improved polishing slurry which can suppress the occurrence of scratches and the like and can obtain a stable polishing effect.

As a result of eager study to achieve the above object, the present inventors found that a dispersion solution prepared by adding the fluorine-based surfactant as a surfactant for dispersing the fluorinated ND in the aqueous medium can stably remain without making any settlement over a long period of time (i.e., over 200 hours) and can hardly raise the problem for CMP such as scratches, thereby reaching the present invention.

An aspect of the present invention resides in a polishing slurry for CMP which slurry includes an aqueous medium. A fluorinated nanodiamond is provided to be contained in the aqueous medium. Additionally, a fluorine-based surfactant is contained in the aqueous medium.

Another aspect of the present invention resides in the polishing slurry in which the fluorine-based surfactant is in amount ranging from 0.1 to 5% by weight relative to the total weight of the aqueous medium and the fluorine-based surfactant. Additionally, the fluorinated nanodiamond is in amount ranging from 0.1 to 5% by weight relative to the total weight of the polishing slurry.

### DETAILED DESCRIPTION OF THE INVENTION

The present invention will be more specifically discussed hereinafter.

A fluorinated ND according to the present invention, which is contained in an aqueous medium of a polishing slurry, is produced by a direct reaction of ND and a fluorine gas or by fluorinating ND with a fluorine plasma. The fluorinated ND preferably has a fluorine content of not less than 10% by weight. When the fluorine content is less than 10% by weight, there arises a fear that a chemical polishing effect expected at a CMP process is so reduced as to make a polishing rate insufficient. Additionally, it is preferable that ND reacts with fluorine only at the outermost surface thereof. In other words, fluorine is preferably added only to a surface layer. When fluorine is added to the inner of the surface layer, a part of or the whole of a diamond structure may be destroyed. This sometimes brings about a particle size dispersion and a particle strength reduction. By the way, the possible fluorine content of the fluorinated ND depends on the particle size of a primary particle of ND. Assuming that the crystal structure of ND is e.g. an octahedral single crystal in a case where fluorine is added only to the surface layer of ND, the possible fluorine content is to be about 34% by weight when each primary particle has a particle size of 3 nm, while 14.5% by weight when each primary particle has a particle size of 10 nm in particle size.

A fluorine-based surfactant (or a fluorine-based surface active agent) used in the present invention contributes to improvements in water repellency by which the fluorinated ND is not wetted with the aqueous medium and to homogenous dispersion of particles in the medium. The fluorine-based surfactant, which is defined by surfactants having not hydrocarbon chains but fluorocarbon chains as a hydrophobic group, is characterized by its surface activity much stronger than that of common surfactants (or hydrocarbon-based surfactants having hydrocarbon chains). Though some kinds of the hydrocarbon-based surfactants contribute to improvements in water repellency by which the fluorinated ND is not wetted with the aqueous medium, slurries obtained from the hydrocarbon-based surfactants are poor in long-term stability and the like, so that it is required to use the fluorine-based surfactant. Examples of the fluorine-based surfactant are: perfluoroalkyl(C₂-C₁₀)carboxylic acid; disodium N-perfluorooctanesulfonylglutamic acid; sodium 3-[fluoroalkyl(C₆-C₁₁)oxy]-1-alkyl(C₃-C₄)sulfonic acid; sodium 3-[ω-fluoroalkanoyl(C₆-C₈)—N-ethylamino]-1-propanesulfonic acid; N-[3-(perfluorooctanesulfonamide)propyl]-N,N-dimethyl-N— carboxymethylene ammonium betaine; fluoroalkyl(C₁₁-C₂₀)carboxylic acid; perfluoroalkyl(C₇-C₁₃)carboxylic acid, perfluorooctanesulfonic acid diethanolamide; lithium perfluoroalkyl(C₄-C₁₂)sulfonic acid; potassium perfluoroalkyl(C₄-C₁₂)sulfonic acid; sodium perfluoroalkyl(C₄-C₁₂)sulfonic acid; N-propyl-N-(2-hydroxyethyl)perfluorooctanesulfonamide; perfluoroalkyl(C₆-C₁₀)sulfonamidepropyltrimethylammonium salt; potassium perfluoroalkyl(C₆-C₁₀)—N-ethylsulfonylglycine; phosphoric acid bis(N-perfluorooctylsulfonyl-N-ethylaminoethyl); and monoperfluoroalkyl(C₆-C₁₆)ethyl phosphoric ester, where “Cₓ” (x: a numeric character) denotes that the number of carbon atoms included in an alkyl chain is x.

Examples of the actual products produced by using the above materials are: Novec (FC-4430 and FC-4432) and Fluorad (FC-93, FC-95 and FC-98) available from Sumitomo 3M Limited; Zonyl (210, 225, 321, 8834L, FS-300, FS-500, FS-510, FSA, FSO, FSO-100, FSJ, FSE and FTS) available from Du Pont kabushiki Kaisha; Surflon (S-111N, S-113, S-121, S-131, S-132, S-141, S-145, S-381, S-383 and SA-100) available from AGC SEIMI CHEMICAL CO., LTD.; MEGAFACE (F-114, F-410, F-494, F-443, F-472SF, F-477 and F-479) available from DAINIPPON INK AND CHEMICALS, INCORPORATED; EFTOP (EF-101, EF-105, EF-112, EF-122A and EF-122B) available from JEMCO Inc.; and Ftergent (100C, 110, 150CH, A-K and 501) available from NEOS COMPANY LIMITED.

In a method for preparing the polishing slurry of the present invention, the fluorine-based surfactant is added to water thereby obtaining a mixture. Thereafter, the fluorinated ND is mixed into the mixture and then suspended in the aqueous medium by ultrasonic application (sonication). The thus obtained suspension is classified through centrifugal separation, thereby preparing the polishing slurry. The preparation of the polishing slurry may further include a concentration process using an evaporator and the like, in order to increase the content of fluorinated ND in the slurry.

The amount and the kind of the fluorine-based surfactant which is to be added to water have a profound effect on the content of fluorinated ND in the slurry obtained. The content of fluorinated ND in the slurry is preferably within a range of from 0.1 to 5% by weight, based on the total weight of the slurry obtained. When the content of fluorinated ND is less than 0.1% by weight, the number of fluorinated ND particles is so small as not to exert a sufficient effect of polishing. When the content of fluorinated ND exceeds 5% by weight, the slurry may be gelatinized thereby causing flowability reduction, settlement (or precipitation) and the like, which results in the occurrence of scratches during a polishing process. In order to obtain a slurry containing the above-mentioned amount of fluorinated ND, the content of fluorine-based surfactant ranges preferably from 0.1 to 5% by weight, more preferably from 0.8 to 5% by weight, relative to the total weight of the aqueous medium and the fluorine-based surfactant, though it depends on the kind of the fluorine-based surfactant. When the content of fluorine-based surfactant is less than 0.1% by weight relative to the total weight of the aqueous medium and the fluorine-based surfactant, it is difficult to adequately disperse the fluorinated ND since the water repellency of the fluorinated ND is so large as not to wet the fluorinated ND. Additionally, the fluorine-based surfactant content exceeding 5% by weight hardly affects a wettability of the fluorinated ND even if the fluorine-based surfactant is further contained to exceed 5% by weight. Rather than this, the viscosity of the mixture of the aqueous medium and the fluorine-based surfactant grows high as the content of fluorine-based surfactant is increased, which may bring a dispersibility reduction of fluorinated ND and the flowability reduction of the slurry thereby resulting in the occurrence of scratches during the polishing process. The dispersibility reduction of fluorinated ND is caused by a decrease in the content of fluorinated ND, or by an increase in average particle size.

In order to produce a suspension from which a polishing slurry containing at least 0.1% by weight of fluorinated ND is obtained, it is preferable to apply ultrasonics to the suspension at a power output of 400 watts for at least 0.5 hours. In a case where ultrasonics are applied at a power output of less than 400 watts, where the application time is less than 0.5 hours, or where the dispersing operation is carried out by stirring (using a stirrer or the like) without the ultrasonic application, dispersion of the fluorinated ND is not sufficient thereby making it difficult to produce the suspension having a concentration of dispersed particles of not less than 0.1% by weight.

The slurry prepared in a manner as to subject the suspension obtained by dispersing the fluorinated ND in the aqueous medium to a classification process preferably has the greatest possible particle size of about 300 nm. Additionally, the slurry preferably has an average particle size ranging from about 10 to 150 nm. When the greatest possible particle size and the average particle size in the slurry go out of the above-mentioned range, there arises a possibility that scratches or dishing occurs at the time of polishing.

It is preferable that the suspension subjected to the ultrasonic application thereafter undergoes the classification process under use of a centrifugal separator at a relative centrifugal acceleration of not less than 1800 G for not less than 0.5 hours. When the classification process was carried out at a relative centrifugal acceleration of less than 1800 G or for less than 0.5 hours, particles having a particle size of more than 300 nm can not be sufficiently removed, which does not provide a good dispersion solution. As the other classification process, there is known a filtration method using a filter or the like; however, in this filtration method, particles having a particle size of not more than 300 nm are removed by the filter so that a dispersion solution having a dispersed-particle concentration of not less 0.1% by weight is hardly obtained.

The polishing slurry according to the present invention may contain an additive for the purpose of improving a polishing property. The additive includes: pH-regulating agents; oxidizing agents; defoaming agents; anti-static agents; antioxidants; preservatives; and coloring agents. These additives are not particularly limited in terms of kind and amount for addition, as far as they can achieve the objects of the present invention.

### EXAMPLES

The present invention will be more readily understood with reference to the following Examples in comparison with Comparative Examples; however, these Examples are intended to illustrate the invention and are not to be construed to limit the scope of the invention.

[Preparation of Polishing Slurry]

### Examples 1 to 6

First of all, ND (which is a refined nanodiamond powder having a particle size of from 3 to 10 nm, available from Gansu Lingyun Nano-Material Co., Ltd.) was heated to 400° C. for 3 hours under a pressure of 1 kPa, thereby previously removing water from ND (a drying process). A reaction tube formed of nickel was charged with 20 g of ND thus subjected to the drying process. Then, fluorine gas and argon gas were flown through the reaction tube at 20° C., at flow rates of 20 ml per minute and of 380 ml per minute, respectively. The sample ND was then heated to 400° C. and kept in the flow of fluorine gas and argon gas for 140 hours to be reacted with the fluorine gas, thereby producing fluorinated ND. It was found by the elemental analysis that the thus produced fluorinated ND had a fluorine content of 12% by weight.

There was employed as a fluorine-based surfactant to be added to ultrapure water: Zonyl FSO available from Du Pont kabushiki Kaisha, in Examples 1 to 3; Novec FC-4430 available from Sumitomo 3M Limited, in Examples 4 and 5; and Novec FC-4432 available from Sumitomo 3M Limited, in Example 6. The fluorine-based surfactant was added to ultrapure water such that the content of the fluorine-based surfactant relative to the total weight of the fluorine-based surfactant and the ultrapure water was: 0.2% by weight in Example 1 using Zonyl FSO; 0.8% by weight in Example 2 using Zonyl FSO; 4.0% by weight in Example 3 using Zonyl FSO; 0.8% by weight in Example 4 using Novec FC-4430; 4.0% by weight in Example 5 using Novec FC-4430; and 0.8% by weight in Example 6 using Novec FC-4432, thereby preparing a mixture.

1 g of fluorinated ND was added to 100 ml of the thus obtained mixture of each Example. The mixture was then subjected to ultrasonics by an ultrasonic homogenizer (available from Sonics & Materials, Inc. under the trade name of VCX-750) at a power output of 400 watts for 0.5 hours, thereby obtaining a suspension in which the fluorinated ND was dispersed. Then, the thus obtained suspension underwent a classification process by using a centrifuge (available from HSIANGTHAI MACHINERY INDUSTRY CO., LTD. under the trade name of CN-2060) at 4300 revolutions per minute (rpm), more specifically at a relative centrifugal acceleration of 2000 G. Thereafter, a supernatant liquid made upon the centrifugal separation was extracted to obtain a polishing slurry.

The concentration of particles in the polishing slurry was determined by the weight of particles that remain upon drying 10 g of the polishing slurry at 50° C. to remove a disperse medium therefrom. Further, the maximum particle size and the average particle size were measured by a particle size distribution measuring device (available from OTSUKA ELECTRONICS CO., LTD. under the trade name of FPAR-1000), the device applying a dynamic light scattering method.

### Example 7

As the fluorine-based surfactant to be added to ultrapure water, Zonyl FSO available from Du Pont kabushiki Kaisha was used. The fluorine-based surfactant was added to ultrapure water such that the content of the fluorine-based surfactant relative to the total weight of the ultrapure water and the fluorine-based surfactant added thereto was 5.5% by weight, thereby preparing a mixture.

Then, the procedure of Examples 1 to 6 was repeated. More specifically, 1 g of fluorinated ND was added to 100 ml of the thus obtained mixture. The mixture was then subjected to ultrasonics. Thereafter centrifugal separation was made on the mixture, and then a supernatant liquid made upon the centrifugal separation was extracted to produce a polishing slurry.

The thus obtained polishing slurry had: a particle concentration of 0.4% by weight; a maximum particle size of 310 nm; and an average particle size of 189 nm.

### Example 8

As the fluorine-based surfactant to be added to ultrapure water, Zonyl FSO available from Du Pont kabushiki Kaisha was used. The fluorine-based surfactant was added to ultrapure water such that the content of the fluorine-based surfactant relative to the total weight of the ultrapure water and the fluorine-based surfactant added thereto was 1.0% by weight, thereby preparing a mixture.

1 g of fluorinated ND was added to 100 ml of the thus obtained mixture and then subjected to ultrasonics at a power output of 400 watts for 0.1 hours. Thereafter centrifugal separation was made on the mixture under the same conditions as those in Examples 1 to 6, and then a supernatant liquid made upon the centrifugal separation was extracted to produce a polishing slurry. The thus obtained polishing slurry had: a particle concentration of 0.03% by weight; a maximum particle size of 255 nm; and an average particle size of 104 nm.

### Comparative Example 1

As a hydrocarbon-based surfactant to be added to ultrapure water, ADEKA NOL available from ADEKA CORPORATION was used. The hydrocarbon-based surfactant was added to ultrapure water such that the content of the hydrocarbon-based surfactant relative to the total weight of the ultrapure water and the hydrocarbon-based surfactant added thereto was 0.8% by weight, thereby preparing a mixture.

Then, the procedure of Examples 1 to 6 was repeated. More specifically, 1 g of fluorinated ND was added to 100 ml of the thus obtained mixture and then subjected to ultrasonics. Thereafter centrifugal separation was made on the mixture, and then a supernatant liquid made upon the centrifugal separation was extracted to prepare a polishing slurry. The polishing slurry immediately after preparation had a particle concentration of 0.2% by weight. However, settlement or precipitation occurred within 24 hours of the preparation, which did not provide a polishing slurry keeping the dispersion of particles.

### Comparative Example 2

1 g of ND was added to 100 ml of ultrapure water thereby obtaining a mixture. The mixture underwent the ultrasonic application and the centrifugal separation, under the same conditions as those in Examples 1 to 6. A supernatant liquid made by the centrifugal separation was extracted thereby preparing a polishing slurry. The thus obtained polishing slurry had: a particle concentration of 0.8% by weight; a maximum particle size of 280 nm; and an average particle size of 79 nm.

### Comparative Example 3

0.5 g of diamond powder was added to 100 ml of ultrapure water (commercially available, e.g., from The Nilaco Corporation under the trade name of # 4000), and then subjected to ultrasonics under the same conditions as those in Examples 1 to 6 to prepare a suspension, in which most of particles settled down within 0.1 hours of the preparation. A supernatant liquid made by the settlement was extracted as a polishing slurry. Then, it was found by measurement that the polishing slurry had a particle concentration of not larger than 0.01% by weight so as not to keep the dispersion of particles.

The above description including the results in each example is summarized in Table 1.

TABLE 1

| | | | Particle | | |
|---|---|---|---|---|---|
| | Surfactant | | concentration | Maximum | Average |
| | | Amount for | of polishing | particle size | particle size |
| Examples | Kind | addition (wt %) | slurry (wt %) | (nm) | (nm) |
| Example 1 | Zonyl FSO | 0.2 | 0.2 | 250 | 106 |
| Example 2 | | 0.8 | 0.7 | 240 | 114 |
| Example 3 | | 4.0 | 1.2 | 290 | 148 |
| Example 4 | Novec | 0.8 | 0.8 | 220 | 108 |
| Example 5 | FC-4430 | 4.0 | 0.9 | 260 | 112 |
| Example 6 | Novec | 0.8 | 0.4 | 260 | 107 |
| | FC-4432 | | | | |
| Example 7 | Zonyl FSO | 5.5 | 0.4 | 310 | 189 |
| Example 8 | | 1.0 | 0.03 | 255 | 104 |

| | | | | |
|---|---|---|---|---|
| Comparative | Adekanol | 0.8 | 0.2 | — |
| Example 1 | | | | |

| | | | | |
|---|---|---|---|---|
| Comparative | — | 0.8 | 280 | 79 |
| Example 2 | | | | |

| | | |
|---|---|---|
| Comparative | ≦0.01 | — |
| Example 3 | | |

[Polishing Test]

A test piece was prepared in such a manner as to deposit copper on a Si substrate by a sputtering method. The thus obtained test piece was previously subjected to a primary polishing with a commercially available slurry for CMP so as to have a surface roughness (Ra) of 10 nm at its polished surface, thereby producing an object to be polished, the slurry containing colloidal silica as an abrasive grit and having a maximum particle size of 700 nm and an average particle size of 120 nm. Polishing tests were conducted on the object to be polished by using a CMP equipment and the polishing slurry obtained in each of Examples 1 to 8 and Comparative Example 2. Additionally, the commercially available CMP slurry was used as Comparative Example 4, the slurry containing colloidal silica as the abrasive grit and being employed in the above-mentioned primary polishing.

The polishing tests were carried out by polishing the object to be polished for 30 minutes under conditions of: 150 gf/cm² of polishing pressure; 25 ml/min of slurry flow rate; 120 rpm of rotational speed of polishing pad or base plate; 120 rpm of rotational speed of the substrate. Further, the polishing rate and surface roughness (Ra) were measured. Furthermore, the presence or absence of scratches was confirmed.

The polishing rate was determined in such a manner as to observe a difference in film thickness between prior to and subsequent to the polishing test by using an atomic force microscope (AFM), and then divide the difference by a period of time during the polishing test. Further, an average polishing rate was determined from each polishing rate obtained by repeating the polishing test 10 times under the above conditions. Furthermore, a difference between the highest and lowest polishing rates (in the 10-times repetition of the test) was obtained and evaluated with the following criteria:

A: a difference between the highest and lowest polishing rates was less than 10 nm/min

B: a difference between the highest and lowest polishing rates was not less than 10 nm/min and less than 20 nm/min

C: a difference between the highest and lowest polishing rates was not less than 20 nm/min and less than 200 nm/min

The surface roughness (Ra) that the polished object had at its polished surface on an area of 2 μm×2 μm was measured by means of AFM and a surface state measurement equipment adopting an optical interferometry. Additionally, the polished object was observed after the polishing test in its freely selected 10 areas (each of which was 100 μm>×100 μm), by means of a scanning electron microscope (SEM). With this, the presence or absence of scratches was visually confirmed and evaluated with the following criteria:

A: the polished object had 0 to 2 scratches

B: the polished object had 3 to 5 scratches

C: the polished object had such a great number of scratches as not to be counted

Results are summarized in Table 2.

TABLE 2

| | Average | | | |
|---|---|---|---|---|
| | polishing rate | Difference in | | |
| Examples | (nm/min) | polishing rate | Ra (nm) | Scratches |
| Example 1 | 98 | A | 0.22 | B |
| Example 2 | 120 | A | 0.29 | A |
| Example 3 | 218 | A | 0.42 | A |
| Example 4 | 115 | A | 0.31 | A |
| Example 5 | 201 | A | 0.45 | A |
| Example 6 | 115 | A | 0.29 | A |
| Example 7 | 421 | B | 1.21 | B |
| Example 8 | 67 | B | 0.72 | B |
| Comparative | *1 | | 5.21 | C |
| Example 2 | | | | |
| Comparative | 220 | B | 2.25 | C |
| Example 4 | | | | |

*1) The polishing rate was so small as not to be measured

From the above Table 2, the polishing slurry of the present invention (Examples 1 to 8) is found to have a consistent polishing rate and to allow such a polishing as to be excellent in planarizing ability with hardly any scratch.

According to the present invention, the polishing slurry for CMP can improve the polishing rate and can hardly raise the problems such as scratches thereby providing a stable polishing effect, while having compatibility with conventional CMP apparatuses. Additionally, according to the present invention, polishing can be efficiently carried out also on the insulating layer which is a portion of the semiconductor device other than the metal wiring portion.

The entire contents of Japanese Patent Applications P2006-306585 (filed Nov. 13, 2006) and P2007-192130 (filed Jul. 24, 2007) are incorporated herein by reference.

Although the invention has been described above by reference to certain embodiments and examples of the invention, the invention is not limited to the embodiments and examples described above. Modifications and variations of the embodiments and examples described above will occur to those skilled in the art, in light of the above teachings. The scope of the invention is defined with reference to the following claims.

What is claimed is:

1. A polishing slurry for a chemical mechanical polishing, comprising:
an aqueous medium;
a fluorinated nanodiamond contained in the aqueous medium; and
a fluorine-based surfactant contained in the aqueous medium.

2. A polishing slurry as claimed in claim 1, wherein the fluorine-based surfactant is in amount ranging from 0.1 to 5% by weight relative to the total weight of the aqueous medium and the fluorine-based surfactant, wherein the fluorinated nanodiamond is in amount ranging from 0.1 to 5% by weight relative to the total weight of the polishing slurry.
